(19) United States
(12) Patent Application Publication
(10) Pub. No.: US 2025/0071633 A1
(43) Pub. Date: Feb. 27, 2025

(54) USER EQUIPMENT, BASE STATION, AND METHOD FOR CONTROLLING A HYBRID AUTOMATIC REPEAT REQUEST (HARQ) PROCESS

(71) Applicant: SHARP KABUSHIKI KAISHA, Saka City, Osaka (JP)

(72) Inventors: YUNG-LAN TSENG, Taipai (TW); YEN-HUA LI, Taipai (TW)

(21) Appl. No.: 18/724,895

(22) PCT Filed: Dec. 27, 2022
(86) PCT No.: PCT/CN2022/142146

§ 371 Date: Jun. 27, 2024

Related U.S. Application Data
(60) Provisional application No. 63/266,048, filed on Dec. 27, 2021.

(51) Int. Cl. H04W 36/00; H04L 1/1829; H04W 36/36

(52) U.S. Cl. CPC H04W 36/0072; H04L 1/1864; H04W 36/362

(57) ABSTRACT

A method performed by a user equipment (UE) for controlling a hybrid automatic repeat request (HARQ) process is provided. The method includes receiving a handover command from a serving cell via broadcast signalling, the handover command including at least one of a HARQ feedback configuration or a HARQ state configuration associated with a candidate cell for a handover procedure; and applying the at least one of the HARQ feedback configuration or the HARQ state configuration after selecting the candidate cell as a target cell during the handover procedure.

### CROSS-REFERENCE TO RELATED APPLICATION(S)

This application is the National Stage Application of International Patent Application Serial No. PCT/CN2022/142146, filed on Dec. 27, 2022, which claims the benefit of and priority to U.S. Provisional Patent Application Ser. No. 63/266,048, filed on Dec. 27, 2021, the contents of all of which are hereby incorporated herein fully by reference in their entirety for all purposes.

### FIELD

The present disclosure is related to wireless communication and, more specifically, to a user equipment (UE), a base station (BS), and a method for controlling a hybrid automatic repeat request (HARQ) process.

### BACKGROUND

Various efforts have been made to improve different aspects of wireless communication for cellular wireless communication systems, such as the 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to a user equipment (UE), a base station (BS), and a method for controlling a hybrid automatic repeat request (HARQ) process.

In a first aspect of the present disclosure, a method performed by a UE for controlling a HARQ process is provided. The method includes receiving a handover command from a serving cell via broadcast signalling, the handover command including at least one of a HARQ feedback configuration or a HARQ state configuration associated with a candidate cell for a handover procedure; and applying the at least one of the HARQ feedback configuration or the HARQ state configuration after selecting the candidate cell as a target cell during the handover procedure.

In an implementation of the first aspect, the at least one of the HARQ feedback configuration or the HARQ state configuration is applied upon or after transmitting a radio resource control (RRC) reconfiguration complete message to the candidate cell.

In another implementation of the first aspect, the HARQ feedback configuration includes a bit string associated with a plurality of HARQ processes of a HARQ entity associated with the candidate cell, and each bit of the bit string is used to enable or disable a downlink (DL) HARQ feedback sent in an uplink (UL) direction for a respective one of the plurality of HARQ processes.

In another implementation of the first aspect, the HARQ state configuration includes a bit string associated with a plurality of HARQ processes of a HARQ entity associated with the candidate cell; each bit of the bit string is used to set a HARQ state for a respective one of the plurality of HARQ processes; and the HARQ state indicates whether a reception of an UL retransmission grant for the respective one of the plurality of HARQ processes is enabled or disabled.

In another implementation of the first aspect, one or more HARQ processes of a HARQ entity associated with the target cell are activated by the serving cell via the broadcast signalling, the broadcast signalling including system information; and the at least one of the HARQ feedback configuration or the HARQ state configuration is applied only to the activated one or more HARQ processes associated with the target cell.

In another implementation of the first aspect, each of the serving cell and the candidate cell is a non-terrestrial network (NTN) cell or a terrestrial network (TN) cell; the TN cell includes an evolved universal terrestrial radio access (E-UTRA) cell or a new radio (NR) cell; and the handover command is a conditional handover command and the handover procedure is a conditional handover procedure.

In another implementation of the first aspect, determining a default HARQ feedback configuration as enabled for each activated HARQ process of multiple HARQ processes of a HARQ entity associated with the candidate cell in a case that the handover command does not include the HARQ feedback configuration associated with the candidate cell; and determining a default HARQ state configuration as enabled for each activated HARQ process in a case that the handover command does not include the HARQ state configuration associated with the candidate cell.

In a second aspect of the present disclosure, a UE for controlling a HARQ process is provided. The UE includes at least one processor; and at least one non-transitory computer-readable medium coupled to the at least one processor and storing one or more computer-executable instructions that, when executed by the at least one processor, cause the UE to receive a handover command from a serving cell via broadcast signalling, the handover command including at least one of a HARQ feedback configuration or a HARQ state configuration associated with a candidate cell for a handover procedure; and apply the at least one of the HARQ feedback configuration or the HARQ state configuration after selecting the candidate cell as a target cell during the handover procedure.

In a third aspect of the present disclosure, a BS for controlling a HARQ process is provided. The BS includes at least one processor; and at least one non-transitory computer-readable medium coupled to the at least one processor and storing one or more computer-executable instructions that, when executed by the at least one processor, cause the BS to transmit, via a serving cell, to a UE, a handover command via broadcast signalling, the handover command including at least one of a HARQ feedback configuration or a HARQ state configuration associated with a candidate cell for a handover procedure; and apply the at least one of the HARQ feedback configuration or the HARQ state configuration associated with the candidate cell in a case that the candidate cell is selected by the UE as a target cell during the handover procedure.

In an implementation of the third aspect, the at least one of the HARQ feedback configuration or the HARQ state configuration is applied upon or after receiving an RRC reconfiguration complete message from the UE.

In another implementation of the third aspect, the HARQ feedback configuration includes a bit string associated with a plurality of HARQ processes of a HARQ entity associated with the candidate cell; and each bit of the bit string is used to enable or disable a DL HARQ feedback sent in an UL direction for a respective one of the plurality of HARQ processes.

In another implementation of the third aspect, the HARQ state configuration includes a bit string associated with a plurality of HARQ processes of a HARQ entity associated with the candidate cell; each bit of the bit string is used to set a HARQ state for a respective one of the plurality of HARQ processes; and the HARQ state indicates whether a reception of an UL retransmission grant for the respective one of the plurality of HARQ processes is enabled or disabled.

In another implementation of the third aspect, one or more HARQ processes of a HARQ entity associated with the target cell are activated by the serving cell via the broadcast signalling, the broadcast signalling including system information; and the at least one of the HARQ feedback configuration or the HARQ state configuration is applied only to the activated one or more HARQ processes associated with the target cell.

In another implementation of the third aspect, each of the serving cell and the candidate cell is an NTN cell or a TN cell; the TN cell includes an E-UTRA cell or an NR cell; and the handover command is a conditional handover command and the handover procedure is a conditional handover procedure.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a diagram illustrating an example of a Non-Terrestrial Network (NTN) with a Low Earth Orbit (LEO) satellite implementing a transparent payload at orbit 600 km, according to an example implementation of the present disclosure.

FIG. 2 is a diagram illustrating an NTN, according to an example implementation of the present disclosure.

FIG. 3 is a message sequence chart illustrating a handover procedure performed via a 4-step RA procedure, according to an example implementation of the present disclosure.

FIG. 4 is a message sequence chart illustrating a handover procedure performed via a 2-step RA procedure, according to an example implementation of the present disclosure.

FIG. 5 is a message sequence chart illustrating a handover procedure performed via a RACH-less handover procedure, according to an example implementation of the present disclosure.

FIG. 6 is a flowchart illustrating a method/process performed by a UE for controlling a HARQ process, according to an example implementation of the present disclosure.

FIG. 7 is a flowchart illustrating a method/process performed by a BS for controlling a HARQ process, according to an example implementation of the present disclosure.

FIG. 8 is a block diagram illustrating a node for wireless communication, in accordance with various aspects of the present disclosure.

### DETAILED DESCRIPTION

Some of the abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| AP | Aperiodic |
| AS | Access Stratum |
| BFR | Beam Failure Recovery |
| BS | Base Station |
| BWP | Bandwidth Part |
| C-DRX | Connected mode Discontinuous Reception |
| CA | Carrier Aggregation |
| CN | Core Network |
| CSI-IM | Channel Status Information-Interference Measurement |
| CSI-RS | Channel Status Information-Reference Signal |
| DAPS | Dual Active Protocol Stack |
| DC | Dual Connectivity |
| DCI | Downlink Control Information |
| DL | Downlink |
| DRX | Discontinuous Reception |
| E-UTRA | Evolved Universal Terrestrial Radio Access |
| E-UTRAN | Evolved Universal Terrestrial Radio Access Network |
| EPC | Evolved Packet System |
| FoV | Field of View |
| GEO | Geostationary Earth Orbit |
| GNSS | Global Navigation Satellite System |
| GW | Gateway |
| HARQ | Hybrid Automatic Repeat Request |
| HPN | HARQ Process Number |
| IE | Information Element |
| IoT | Internet of Things |
| L1 | Layer-1 |
| LBT | Listen Before Talk |
| LCP | Logical Channel Prioritization |
| LEO | Low Earth Orbit |
| LTE | Long-Term Evolution |
| MAC | Medium Access Control |
| MAC CE | MAC Control Element |
| MCG | Master Cell Group |
| MCS | Modulation Coding Scheme |
| MN | Master Node |
| NACK | Negative Acknowledgement |
| NAS | Non-Access Stratum |
| NB-IoT | Narrowband Internet of Things |
| NDI | New Data Indicator |
| NR | New Radio |
| NTN | Non-Terrestrial Network |
| NW | Network |
| OFDM | Orthogonal Frequency Division Multiplexing |
| PCell | Primary Cell |
| PDCCH | Physical Downlink Control Channel |
| PDSCH | Physical Downlink Shared Channel |
| PDU | Protocol Data Unit |
| PLMN | Public Land Mobile Network |
| PNI-NPN | Public Network Integrated-NPN |
| PSFCH | Physical Sidelink Feedback Channel |
| PUCCH | Physical Uplink Control Channel |
| PUSCH | Physical Uplink Shared Channel |
| RA | Random Access |
| RAR | Random Access Response |
| RAT | Radio Access Technology |
| RB | Radio Bearer |
| RAN | Radio Access Network |
| RF | Radio Frequency |
| RRC | Radio Resource Control |
| RS | Reference Signal |
| RTT | Round Trip Time |
| RV | Redundancy Version |
| SL | Sidelink |
| SCell | Secondary Cell |
| SCG | Secondary Cell Group |
| SI | System Information |
| SIB | System Information Block |
| SN | Secondary Node |
| SNPN | Standalone Non-Public Network |
| SP | Semi-Persistent |
| SPS | Semi-Persistent Scheduling |
| SRB | Signaling Radio Bearer |
| SRS | Sounding Reference Signal |
| TA | Tracking Area |
| TB | Transport Block |
| TCI | Transmission Configuration Indicator |
| TDD | Time Division Duplex |
| TN | Terrestrial Network |
| TS | Technical Specification |
| TTI | Transmission Time Interval |
| UE | User Equipment |
| UL | Uplink |
| URLLC | Ultra-Reliable and Low-Latency Communication |
| ZP | Zero Power |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present disclosure,” etc., may indicate that the implementation(s) of the present disclosure so described may include a particular feature, structure, or characteristic, but not every possible implementation of the present disclosure necessarily includes the particular feature, structure, or characteristic. Further, repeated use of the phrase “in one implementation,” “in an example implementation,” or “an implementation,” do not necessarily refer to the same implementation, although they may. Moreover, any use of phrases like “implementations” in connection with “the present disclosure” are never meant to characterize that all implementations of the present disclosure must include the particular feature, structure, or characteristic, and should instead be understood to mean “at least some implementations of the present disclosure” include the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer-executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or using one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT), such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next-generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next-generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

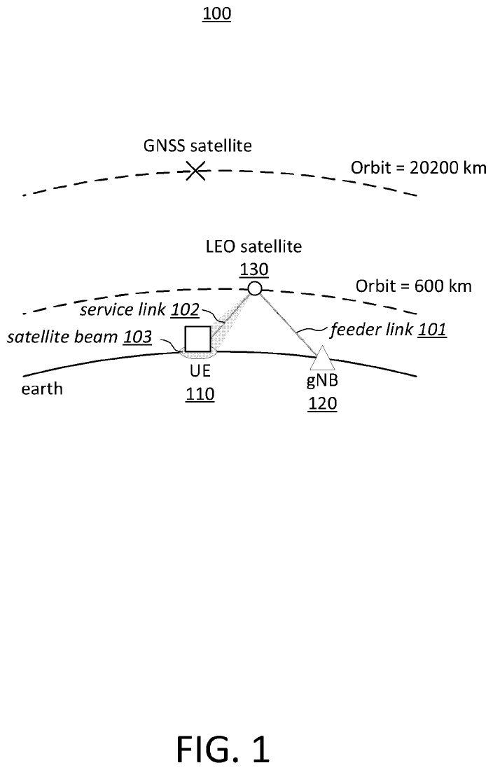

An NTN may refer to a NW, or segments of a NW, using spaceborne vehicle(s), such as an LEO or GEO satellite(s), for transmission. FIG. 1 is a diagram 100 illustrating an example of an NTN with an LEO satellite 130 implementing a transparent payload at orbit 600 km, according to an example implementation of the present disclosure. An NTN typically includes at least the following elements: (1) a gateway (GW) (not illustrated in FIG. 1); (2) a base station (e.g., gNB 120); (3) a satellite 130; and (4) a UE 110. A ground or earth station may include a Satellite-gateway (Sat-gateway) and a Telemetry, Tracking, Command, and Monitoring (TTC & M) unit. One or several Sat-gateways may be attached to a BS baseband unit (BBU) or a BS (e.g., gNB) that connects the NTN to a core network or an application server. The gNB is used as an example for the BS here. It should be noted that the term “gNB” in this disclosure may refer to any other type of BS, such as an NB, an eNB, an RNC, a BSC, an ng-eNB, a gNB, or any other apparatus capable of controlling radio communication and managing radio resources within a cell. Node BBUs may be close to the Sat-gateways (e.g., either co-located or within a few kilometers), and the antenna diversity may be required depending on the geographical location and the feeder-link frequency band. The satellite may be a GEO or a non-GEO satellite. The satellite may be part of a satellite constellation to ensure the service continuity and may be served successively by one or several Sat-gateways. A satellite constellation controller may provide each BS with satellite system data (e.g., ephemeris, satellite position, velocity, etc.). The feeder link 101 may refer to a radio link conveying information for a satellite mobile service between a Sat-gateway and the satellite. A service link 102 may refer to a radio link between the UE and the satellite. The satellite may implement a transparent payload. A transparent payload may include different operations, such as RF filtering, frequency conversion, amplification, etc., and the waveform signal repeated by the payload may be unchanged except for the frequency translation and the transmission power. A satellite typically generates several spot-beams (e.g., the satellite beam 103) over a given service area bounded by its Field of View (FoV) or footprint. The footprints of the spot-beams typically form an elliptic shape. The UE may be a GNSS-capable UE, such as a handheld device (e.g., an NR or LTE smartphone), an IoT device (e.g., an NB-IoT or eMTC device), a very-small-aperture terminal (VSAT), a moving platform (e.g., an aircraft, vessel, or building-mounted device), etc.

In an NTN, there may be several different scenarios, including the quasi-earth-fixed scenario, the earth-moving scenario, and the feeder-link-switch scenario. The quasi-earth-fixed scenario may refer to the case where a geographic area is served for one period and a different geographic area is served for another period. A platform, such as an LEO satellite, may create the quasi-earth-fixed beams if the satellite beam steering is supported. Handovers typically occur in bursts for all the UEs in each coverage area, e.g., every few minutes, in the quasi-earth-fixed scenario. The earth-moving scenario may refer to the case where a different geographic area is served from one instant to the next. The overall coverage area of the beams may be changing continuously. A platform, such as an LEO satellite, may use the earth-moving beams and may cover different geographic areas, as the platform keeps orbiting the earth. When an NTN cell uses an earth-moving beam, every stationary UE may experience a change in the cell frequently, e.g., every few seconds. Handovers typically occur continuously in the earth-moving scenario. In the feeder-link-switch scenario, the timing information of a cell that is going to start or stop serving the area for the earth-fixed scenario may be broadcast to the UE via system information. The feeder-link-switch scenario may refer to the case where a link changes between the satellite and the GW, which may be co-located with a gNB. The duration of the feeder-link switch may be predictable based on the satellite ephemeris and the GW's location. The NW may broadcast the feeder-link switch period for the UE to stop or start the measurements, transmissions, or receptions.

Hybrid automatic repeat request (HARQ) is associated with a retransmission scheme. Take the asynchronous HARQ used in NR as an example. In the DL HARQ operation, if the UE successfully decodes a TB, the UE may transmit an ACK feedback to the gNB. Otherwise, if the UE fails to decode the TB, the UE may transmit a NACK feedback to the gNB and the gNB may schedule a retransmission via a DCI format 1_0 or 1_1. The UE may identify the retransmission by a non-toggled new data indicator (NDI) bit in the DL assignment DCI for the same HARQ process number (HPN). In the UL HARQ operation, if the gNB successfully decodes a TB from the UE, the gNB may not transmit an ACK feedback to the UE. Otherwise, if the gNB fails to decode a TB from the UE, the gNB may not transmit a NACK feedback to the UE and may schedule a retransmission via a DCI format 0_0 or 0_1. The UE may identify the retransmission by a non-toggled NDI bit in the UL grant DCI for the same HPN. In addition, multiple HARQ processes may operate in parallel to utilize the time resources more efficiently during the DL or UL HARQ operation. The maximum number of HARQ processes may be limited by the RTT, TTI, and/or the UE processing time.

In the 3GPP New Radio (NR), asynchronous Incremental Redundancy HARQ is supported. The gNB may provide the UE with the HARQ-ACK feedback timing either dynamically in the DCI or semi-statically in an RRC configuration. Retransmission of HARQ-ACK feedback may be supported by using enhanced dynamic codebook and/or one-shot triggering of a HARQ-ACK transmission for (i) all configured Component Carriers and HARQ processes in the PUCCH group, (ii) a configured subset of Component Carriers and/or HARQ processes in the PUCCH group, or (iii) a dynamically indicated HARQ-ACK feedback instance. For HARQ-ACK of an SPS PDSCH without an associated PDCCH, in case of a HARQ-ACK dropping due to the TDD specific collisions, the HARQ-ACK feedback may be deferred to a next available PUCCH transmission occasion. Therefore, in some implementations, besides the candidate cell, the serving cell or the source cell may also configure the HARQ feedback configuration and/or the HARQ state configuration associated with one or more secondary cells and/or PUCCH group(s) that are pre-configured to the UE in the same broadcasting handover command. The UE and the serving RAN (e.g., which may include at least the target cell selected by the UE or one or more pre-configured secondary cell(s)) may apply the broadcast HARQ feedback configuration and/or the HARQ state configuration upon or after the (conditional) handover procedure.

It should also be noted that, in some implementations, in the broadcasting handover command, one HARQ feedback configuration and/or HARQ state configuration may be associated with exactly one candidate cell, and each candidate cell may be associated with one independent HARQ feedback configuration and/or one HARQ state configuration. In some implementations, one HARQ feedback configuration and/or HARQ state configuration may be associated with more than one candidate cell (e.g., a subset of candidate cells or all of the candidate cells in the handover command).

In some implementations, the UE may be configured to receive code block group (CBG)-based transmissions where retransmissions may be scheduled to carry a sub-set of all the code blocks of a TB.

It should also be noted that, in some implementations, the NTN cells may also support an SL HARQ feedback configuration on a PC5 interface (e.g., the NR PC5 interface, or the E-UTRA PC5 interface) to enable or disable a UE to transmit the SL-HARQ feedback information (e.g., on the 10 Physical Sidelink Feedback Channel, PSFCH) associated with one or more SL HARQ processes on one or more SL component carriers and SL-BWPs. Based on the proposed mechanism, the broadcasting handover command may also include the SL HARQ feedback configuration associated with one or more candidate cell(s). So, the UE may also implement the configured SL-HARQ feedback configuration upon or after the handover procedure.

In this disclosure, solutions to enhance the AS layer (e.g., Layer-2/Layer-1) control mechanisms for the NTNs are provided. The present disclosure includes the following sections: 1) designs for the HARQ feedback configuration and/or the HARQ state configuration; 2) enhancements on the RA procedure for the NTN; 3) HARQ feedback configuration and/or HARQ state configuration for specific signaling, purpose, or RB; and 4) further enhancements for the NTN network management.

### Designs for HARQ Feedback Configuration and/or HARQ State Configuration

In this section, different designs for supporting the (DL/UL) HARQ feedback configuration and/or HARQ state configuration at the UE side and the network side (e.g., serving RAN) are provided.

### 1. HARQ Entity at the UE Side for the DL Direction

In some implementations, for the DL direction, the HARQ feedback configuration may be enabled or disabled (e.g., per HARQ process). The HARQ feedback configuration may also be configured with different entities (e.g., per cell, per UE, per cell group, per MAC entity, per frequency carrier, or per HARQ entity).

Per-cell designs for HARQ feedback configuration and/or HARQ state configuration are described as follows. In some implementations, a BS or a cell may broadcast the HARQ feedback configuration (e.g., indicating whether the HARQ ACK/NACK information delivery is enabled or disabled) via broadcast control signaling (e.g., via one or more system information blocks (SIBs), via the broadcasting procedure, via the system information (SI) on-demand procedure, or via UE-specific dedicated signaling). In addition, the HARQ feedback configuration may be transmitted via a SIB1 or another SIB (e.g., a SIB specific for NTN, or called an NTN SIB). A UE may configure or reconfigure, based on the HARQ feedback configuration received from the serving cell, all of the activated HARQ processes with the HARQ feedback configuration or the HARQ state configuration which is set to ‘enabled’ or ‘disabled’. It should be noted that, in some implementations, the serving cell may not broadcast the HARQ feedback configuration, and the UE may remove the HARQ feedback configuration associated with the MAC entity, the HARQ entity, or the HARQ process (e.g., if there are any configured MAC entity, HARQ entity, or HARQ process in the UE).

Per-UE designs for HARQ feedback configuration and/or HARQ state configuration are described as follows. In some implementations, a UE may be configured with the HARQ feedback configuration which is set to ‘enabled’ or ‘disabled’, via a UE-specific configuration (e.g., via DL control signaling, such as an RRCReconfiguration message). All of the HARQ processes configured (e.g., for the DL direction) in the UE may be enabled to transmit the HARQ ACK/NACK information to the serving cell if the HARQ feedback configuration is set to ‘enabled’. Otherwise, if the HARQ feedback configuration is set to ‘disabled’, all of the HARQ processes configured (e.g., for the DL direction) in the UE may be disabled for transmitting the HARQ ACK/NACK information (e.g., a HARQ ACK/NACK indication used to inform the transmitter of the status of a received TB associated with a HARQ process) to the serving cell. In some implementations, the UE may not be configured with the HARQ feedback configuration by the serving cell. For example, the UE may release or remove the stored HARQ feedback configuration associated with the MAC entity, the HARQ entity, or the HARQ process (if there is any) after receiving UE-specific dedicated control signaling without being configured with the HARQ feedback configuration and/or the HARQ state configuration. In some implementations, the serving cell may instruct the UE to release, or remove, the stored HARQ feedback configuration via UE-specific control signaling, and the UE may release, or remove, the stored HARQ feedback configuration associated with the MAC entity, the HARQ entity, or the HARQ process (if there is any) upon receiving such an instruction. In addition, the HARQ process may be reconfigured as a legacy HARQ process (e.g., a HARQ process without the HARQ feedback configuration) once the associated HARQ feedback configuration is released or removed.

Per-MAC-entity or per-cell-group designs for HARQ feedback configuration and/or HARQ state configuration are described as follows. In some implementations, a UE may be configured with the HARQ feedback configuration in the cell group configuration (e.g., master cell group (MCG) or secondary cell group (SCG) configuration) via UE-specific control signaling (e.g., an RRCReconfiguration message). In some implementations, the UE may implement dual-connectivity (DC) or multi-RAT dual connectivity (MR-DC) based on the configured cell group configurations. In some implementations, the UE may implement or generate one or more MAC entities, each of which is associated with one cell group (e.g., an MCG or an SCG). In this case, each MAC entity may be further associated with one specific HARQ feedback configuration. In addition, the MAC entity may apply the received or stored HARQ feedback configuration to all of the NTN frequency carriers, the HARQ entities, or the HARQ processes generated/activated by the MAC entity. In some implementations, the serving RAN may configure the HARQ feedback configuration to each cell group independently.

Per-NTN-frequency-carrier or per-HARQ-entity designs for HARQ feedback configuration and/or HARQ state configuration are described as follows. In some implementations, the UE may be configured with one or more NTN frequency carriers (e.g., for data or signaling exchange). Moreover, the UE may operate on one or more active NTN frequency carriers simultaneously. In some implementations, each frequency carrier may be configured (e.g., independently or parallelly) with one specific HARQ feedback configuration or HARQ state configuration (e.g., the HARQ feedback configuration which is set to ‘enabled’ may enable a UE to transmit the HARQ ACK/NACK information), or the UE may expect to implement the HARQ ACK/NACK information reception procedure within a HARQ process. In some implementations, the HARQ ACK/NACK information reception procedure may influence the Discontinuous Reception (DRX) operation at the UE side. Based on the received HARQ feedback configuration, the UE may enable or disable the HARQ ACK/NACK information delivery based on the HARQ feedback configuration on the associated HARQ entity.

Per-HARQ-process designs for HARQ feedback configuration and/or HARQ state configuration are described as follows. In some implementations, the UE may be configured with one bit string (e.g., with a length of 32 bits or 16 bits) to define the HARQ feedback configuration associated with one specific HARQ process. In some implementations, each bit of the bit string may be (uniquely) associated with one HARQ process and the UE may configure the HARQ feedback configuration of the concerned HARQ process by referring to the associated bit (while the HARQ process is activated or configured by the UE). In some implementations, the UE may be configured with one sequence of indicators or numerators and each indicator/numerator may be associated with one target MAC entity or HARQ entity for the HARQ feedback configuration and/or the HARQ state configuration.

Alternatively, in some implementations, the HARQ feedback configuration and/or HARQ state configuration may be configured per Bandwidth Part (BWP) (e.g., DL-BWP, UL-BWP, or SL-BWP).

Details regarding different formats of the HARQ feedback configuration are described as follows. In some implementation, the HARQ feedback configuration may be realized as a numerator which may be set to ‘enabled’ or ‘disabled’, and the HARQ feedback configuration may be transmitted to a UE for the above-mentioned per-cell, per-UE, per-cell-group, per-MAC-entity, per-HARQ-entity, or per-HARQ-process design scenarios.

In some implementations, a UE may be configured with one bit string (e.g., with a length of 32 bits or 16 bits) to define the HARQ feedback configuration associated with one specific HARQ process. In some implementations, each bit of the bit string may be (uniquely) associated with one HARQ process and the UE may configure the HARQ feedback configuration of the concerned HARQ process by referring to the associated bit (while the HARQ process is activated or configured by the UE). In some implementations, the bit in the HARQ feedback configuration may be set to ‘1’ to indicate the HARQ feedback configuration as ‘enabled’, or the bit may be set to ‘0’ to indicate the HARQ feedback configuration as ‘disabled’.

In some other implementations, there may be one default setting for the HARQ feedback configuration (e.g., the default setting may be that the HARQ feedback configuration is set to ‘enabled’, or the default setting may be that the HARQ feedback configuration is set to ‘disabled’). In some implementations, the HARQ feedback configuration may include only one bit, which is set to ‘1’ to indicate the setting being different from the default setting. Otherwise, the one bit may be set to ‘0’ to indicate that the UE may only need to follow the default setting. The default setting may be pre-defined, as described in 3GPP technical specification(s), or may be pre-configured by the serving RAN, or may be pre-installed in the UE's memory module.

In some additional implementations, the default HARQ feedback configuration and/or the HARQ state configuration may be pre-defined to be associated with one (or more) HARQ process ID(s) (e.g., the HARQ process which a HARQ process ID='0’). In some implementations, this rule may be implicitly supported by the serving RAN and the UE, so that the serving RAN may not need to indicate the default HARQ feedback configuration for the specific HARQ process (e.g., the HARQ process which a HARQ process ID='0’).

### 2. HARQ Entity at the UE Side for the UL Direction

For dynamic grants for UL, a UE may be configured with a (UL) HARQ state configuration (e.g., per HARQ process) that controls the (connected mode) DRX operations. In one MAC entity, one or more logical channels (LCHs) may be configured to be transmitted on one (UL) HARQ state to assist the LCP procedure. If configured, data from the LCH(s) configured with an (UL) HARQ state may only be mapped to the HARQ process configured with the same HARQ state.

In some implementations, the designs proposed for the HARQ feedback configuration (e.g., in the DL direction packet reception) for the HARQ entity at the UE side may also be applied to the HARQ entity at the UE side for the UL direction.

In some implementations, one HARQ state configuration may be applied to both the HARQ entity for the UL direction and the HARQ entity for the DL direction at the UE side. In other words, one common configuration may be used in both of the HARQ feedback configuration and the HARQ state configuration. In some implementations, different HARQ feedback configurations may be separately applied to the HARQ entity for the UL direction and the HARQ entity for the DL direction at the UE side. In other words, different configurations may be separately used in the HARQ feedback configuration and the HARQ state configuration.

### 3. Multiple NTN Frequency Carrier Configurations

In some implementations, a UE may be configured with one or more NTN frequency carriers for the NTN operations.

In some implementations, the UE may receive one general or common configuration (e.g., a bitmap, a bit string, or a set of indicators/enumerators via DL UE-specific RRC signaling) of the HARQ states of each HARQ process. When the UE is operating on the one or more NTN frequency carriers, the UE may also create one or more HARQ entities, each of which may be (uniquely) mapped to one NTN frequency carrier (or each HARQ process may corresponds to one serving cell). In this case, the UE may apply the general or common HARQ state configuration (e.g., received via an RRCReconfiguration message) on each concerned HARQ entity or HARQ process.

In some implementations, each NTN frequency carrier may be associated with one HARQ feedback configuration, and the UE may implement the HARQ feedback configuration based on the operating NTN frequency carrier. In some implementations, the UE may select only one operating NTN frequency carrier among the one or more NTN frequency carriers. In some implementations, the UE may select more than one operating NTN frequency carriers for the NTN operations (e.g., in the CA or DC scenario).

In some implementations, a UE may be configured with one NTN frequency carrier and one TN frequency carrier. In this case, the UE may apply the received/stored HARQ feedback configuration and/or the HARQ state configuration (only) on the NTN frequency carrier and apply the legacy HARQ processes on the TN frequency carrier. In some implementations, the HARQ feedback configuration and/or the HARQ state configuration may also be applied to the terrestrial (cellular) networks and/or TN frequency carrier(s).

### 4. HARQ State Configuration and HARQ Feedback Configuration

In some implementations, one HARQ process may further be configured to be associated with one of the following ‘HARQ state’ (or may be called ‘HARQ mode’): 1) a HARQ feedback enabled state (also known as HARQ state A in some technical documents); 2) a HARQ feedback disabled state (also known as HARQ state B in some technical documents); 3) a legacy HARQ process (e.g., the HARQ process operated without being associated with one HARQ state configuration or HARQ feedback configuration).

The HARQ State A (or may be called HARQ mode A) is that the UE may expect a retransmission grant based on the UL decoding results. The HARQ State B (or may be called HARQ mode B) is that the UE may not expect a retransmission grant based on the UL decoding results (e.g., the UE may support no UL retransmission and/or blind UL retransmission). The UE implementations under different HARQ states are described as follows. In the HARQ State A, the length of the drx-HARQ-RTT-TimerUL timer may be extended by the RTT between the UE and gNB (e.g., the UE PDCCH monitoring is optimized to support UL retransmission grant based on the UL decoding result). In the HARQ State B, the drx-HARQ-RTT-TimerUL timer is not started. Based on the current 3GPP technical specifications, a UE may start the drx-retransmissionTimerUL timer for a corresponding HARQ process in the first symbol after the expiry of the drx-HARQ-RTT-TimerUL timer. 3GPP RAN2 has agreed that the HARQ process configured with the HARQ State B does not start the drx-HARQ-RTT-TimerUL timer. For the DL direction, the UE may reply the HARQ ACK/NACK information to the serving cell if the running HARQ process is associated with a HARQ feedback configuration that is set to ‘enabled’. Otherwise, if the running HARQ process is associated with a HARQ feedback configuration that is set to ‘disabled’, the UE may not reply the HARQ ACK/NACK information to the serving cell. For the UL direction, the UE may determine not to count, start, or activate the DRX timers associated with the running HARQ process if the HARQ process is associated with the HARQ state B or the HARQ state=‘disabled’ (e.g., because the UE may not expect the serving cell to further indicate a re-transmission resource for the TB re-transmission under the same HARQ process in the UL direction). Otherwise, if the HARQ process is associated with the HARQ state A or the HARQ state=‘enabled’ (e.g., because the UE may expect the serving cell to further indicate the re-transmission resource for the TB re-transmission under the same HARQ process in the UL direction), the UE may determine to count, start, or activate the DRX timers associated with the running HARQ process. It should be noted that the UE may determine to count, start, or activate the DRX timers associated with the running HARQ process if the HARQ process is a legacy HARQ process.

In some implementations, a UE may be explicitly configured with a HARQ state=‘enabled’ or ‘disabled’, and accordingly, the UE may enable or disable the HARQ ACK/NACK information delivery associated with the concerned HARQ process.

5. Multiplexing with LCP

In some implementations, the pending data from one or more logical channels associated with the HARQ feedback configuration (or the (UL) HARQ state) that is set to ‘disabled’ may be multiplexed and transmitted via a HARQ process configured with the HARQ state=‘enabled’ (or the HARQ state A) (e.g., if the UL grant is associated with one HARQ process which is configured with the HARQ state=‘enabled’). In some implementations, this case may apply at the UE side only when there is no other pending packets from (all of) the logical channels associated with the HARQ state=‘enabled’. In this case, the UE may generate a HARQ ACK/NACK indicator for the pending packet (e.g., derived from a logical channel with the HARQ state=‘disabled’ or the HARQ state B) as the replied HARQ ACK/NACK information to the serving RAN.

In some implementations, the pending data from a logical channel associated with the HARQ feedback configuration (or the (UL) HARQ state) that is set to ‘enabled’ may be multiplexed and transmitted via a HARQ process configured with the HARQ state=‘disabled’ (or the HARQ state B) (e.g., if the UL grant is associated with one HARQ process which is configured with the HARQ state=‘disabled’). In some implementations, this case may apply at the UE side only when there is no other pending packets from (all of) the logical channels associated with the HARQ state=‘disabled’. In this case, the UE may not generate the HARQ ACK/NACK indicator for the pending packet (e.g., derived from a logical channel with the HARQ state=‘enabled’) as the replied HARQ ACK/NACK information to the serving RAN.

In some implementations, one logical channel may be further associated with one ‘allowedHARQstate’ as ‘HARQ state A’ or ‘HARQ state B’. Based on the configuration of ‘allowedHARQstate’, the pending MAC packets (e.g., MAC Packet Data Units (PDUs) or MAC Service Data Units (SDUs)) of the corresponding logical channel may only be assigned to the HARQ processes associated with the ‘allowedHARQstate’, which may be either the HARQ state A or HARQ state B. For those logical channels which are not configured with ‘allowedHARQstate’, the UE may assign the pending MAC packets to a HARQ process which is either associated with the HARQ state A or HARQ state B. In some implementations, the logical channel configuration along with the IE‘allowedHARQstate’ may also be a part of the broadcasting handover command.

The designs proposed in the multiplexing with LCP may apply to one specific type of service, logical channel, or radio bearer (e.g., when the QoS requirements of the concerned logical channel requires a shorter latency and/or the error rate may not be the concern for the logical channel).

In some implementations, a logical channel may not be explicitly configured with specific requirement of the HARQ state. In this case, it may be based on the UE implementations regarding whether or not to transmit the pending packet(s) from the logical channel via a HARQ process with the HARQ state= ‘enabled’ or ‘disabled’. In some implementations, a HARQ state may be (pre-)defined as a default HARQ state (e.g., HARQ state=‘enabled’) for the UE to determine whether to multiplex pending data of a specific logical channel in a MAC PDU (e.g., that is associated with the HARQ process).

### 6. MAC Reset or Full Configuration

In some implementations, a UE may release, remove, or reset the HARQ feedback configuration and/or HARQ state configuration when the MAC entity is reset by the UE (e.g., based on the description of the 3GPP TS 38.321 or TS 36.321). In some implementations, the UE may consider, reset, (re)activate, or fallback the HARQ processes, as a legacy HARQ process, if the stored HARQ feedback configuration or the HARQ state configuration is released or removed. In some implementations, the UE may reset the HARQ feedback configuration or HARQ state configuration to its default setting during the MAC reset procedure.

In some implementations, a UE may release, remove, or reset the HARQ feedback configuration and/or HARQ state configuration when the UE is implementing the (RRC entity) full configuration procedure (e.g., based on the 3GPP TS 38.331 or TS 36.331). In some implementations, the UE may consider, reset, (re)activate, or fallback the HARQ processes, as a legacy HARQ process (e.g., a HARQ process with the HARQ state A or the HARQ state B, as the default HARQ state), if the stored HARQ feedback configuration or the HARQ state configuration is released or removed. In some implementations, the UE may reset the HARQ feedback configuration or the HARQ state configuration to its default setting during the (RRC entity) full configuration procedure.

In some implementations, different approaches to implement the full configuration may be separately realized for the TN and NTN.

### 7. (RRC) Reconfiguration

In some implementations, a UE may receive an instruction from the serving cell to re-configure (e.g., to modify, add, or delete) the HARQ feedback configuration and/or the HARQ state configuration when the related HARQ process(es) is/are already activated or running in the MAC entity. In this case, the MAC entity may re-configure the HARQ feedback configuration or the HARQ state configuration (only) after the packet (re)transmissions on the concerned (activated) HARQ process are terminated. In other words, the new HARQ feedback configuration or HARQ state configuration may be applied (only) in the next new transmission of the concerned HARQ process (e.g., the new transmission for the HARQ process may be generated for the next TB pending in the buffer) or may be applied the next time, for example, when the concerned HARQ process is re-activated. In some implementations, the UE may determine to re-configure, re-activate, or stop the DRX timers based on the updated or re-configured HARQ state during the (re)transmissions of a pending packet (e.g., a pending TB).

In some implementations, a UE may release, reset, or re-activate the DRX timers associated with the HARQ processes (which the associated HARQ feedback configuration or the HARQ state configuration are modified) only in the following new transmission of the concerned HARQ process when, or upon, the HARQ feedback configuration or the HARQ state configuration is modified, released, added, or configured.

The DRX timers involved may include: 1) drx-RetransmissionTimerDL (per DL HARQ process except for the broadcast process): the maximum duration until a DL retransmission is received; 2) drx-RetransmissionTimerUL (per UL HARQ process): the maximum duration until a grant for an UL retransmission is received; 3) drx-HARQ-RTT-TimerDL (per DL HARQ process except for the broadcast process): the minimum duration before a DL assignment for a HARQ retransmission is expected by the MAC entity; 4) drx-HARQ-RTT-TimerUL (per UL HARQ process): the minimum duration before a UL HARQ retransmission grant is expected by the MAC entity.

In some implementations, a UE may change or modify the HARQ state configuration (e.g., HARQ state A or HARQ state B) (only) upon the MAC reset or when the UE has to reset the HARQ entity.

### 8. Blind Re-Transmission

In some implementations, a UE may apply blind re-transmissions for the HARQ process with the HARQ state=‘disabled’.

Some designs to further address the impact, that the HARQ process configured with blind re-transmission may have, on the C-DRX mechanism are described as follows. In some implementations, any combination of the following options may be considered for supporting the reception of a blind UL retransmission grant for the HARQ process(es) configured with the HARQ mode B: 1) relying on the UE to be in the DRX Active Time via some means (e.g. via the application of the (DRX) Inactivity Timer); 2) starting drx-RetransmissionTimerUL at the end of the PUSCH transmission; and 3) starting drx-RetransmissionTimerUL with the offset indicated by NW after the end of the PUSCH transmission. In some implementations, any combination of the following options may be considered for supporting the reception of a blind retransmission for the HARQ process(es) configured with the HARQ feedback configuration set to ‘disable’: 1) relying on the UE to be in the DRX Active Time via some means (e.g. via the application of the (DRX) Inactivity Timer); 2) starting drx-RetransmissionTimerDL in the first symbol after the end of the reception of the last PDSCH or slot-aggregated PDSCH; 3) starting drx-RetransmissionTimerDL in the first symbol after the end of the reception of the last PDSCH or slot-aggregated PDSCH plus X (X=T_proc,1); 4) starting drx-Retransmission TimerDL with the offset indicated by the NW after the end of the reception of the last PDSCH. For the HARQ process(es) not configured with the HARQ feedback configuration set to ‘enabled’ or ‘disabled’, any combination of the following options may be considered for drx-HARQ-RTT-TimerDL behavior: 1) drx-HARQ-RTT-TimerDL is extended by the RTT between the UE and gNB; and 2) drx-HARQ-RTT-TimerDL is not changed (e.g., legacy behavior is to be applied).

It should be noted that, in some implementations, the UE may implement any of the possible above described implementations (only) after the following new transmission of the concerned HARQ process (e.g., after the HARQ state of the concerned HARQ process is transitioned from HARQ state A (e.g., enabled state) to HARQ state B (e.g., disabled state)). In some implementations, the running (DRX) timers associated with the blind re-transmissions of a HARQ process may still be running or active until the HARQ state of the HARQ process is updated (e.g., from a disabled state to the enabled state) or when all of the blind re-transmissions (of the transmitted TB) are completed. The UE may not change or interrupt the running timers during the packet (re)transmission(s) of the concerned HARQ process.

### 9. Initial Access and Handover

In some implementations, a UE may not be configured with the HARQ feedback configuration or the HARQ state configuration during the initial access procedure. In this case, a default setting (e.g., enabled/disabled) may be pre-configured to the UE. In some implementations, the UE may (only) apply the legacy HARQ processes (e.g., asynchronous HARQ ACK/NACK information transmission via the PUCCH) before the UE receives any HARQ feedback configuration or HARQ state configuration.

In some implementations, a UE may receive the HARQ feedback configuration or the HARQ state configuration associated with one (or more) candidate cell(s) during a (conditional) handover procedure (e.g., the source cell may assist the candidate cell(s) with forwarding the HARQ feedback configuration or the HARQ state configuration associated with the candidate cell(s)). In some implementations, when a UE determines to handover to a target cell (e.g., due to one or more conditional handover requirements being fulfilled), the UE may apply the HARQ feedback configuration or the HARQ state configuration associated with the target cell upon, or after, the UE transmits the RRCReconfigurationComplete message to the target cell. The handover procedure may be an intra-RAT (e.g., within NR RAT) handover procedure, an inter-RAT (e.g., from E-UTRA to NR) handover procedure, an intra-system (e.g., within 5GC core network) handover procedure, or an inter-system (e.g., from EPC to 5GC) handover procedure. In some implementations, the source cell or the target cell may be an NTN cell or a TN cell. In some implementations, the UE may or may not apply the HARQ feedback configuration or the HARQ state configuration which may be decided or configured based on the selected target cell.

In some implementations, the handover procedure may be a Dual-Active Protocol Stack (DAPS) handover procedure. In addition, the two active protocol stacks may each implement a different HARQ feedback configuration and/or a different HARQ state configuration.

### Enhancements on the RA Procedure for NTN

### 1. PDCCH-Order RA Procedure

In some implementations, a serving cell may configure a UE to report the UE's location and/or the UE-specific TA information via an RA procedure instructed by the serving cell (e.g., via a PDCCH command). The RA procedure may be a 2-step RA procedure or a 4-step RA procedure.

In some implementations, a UE may initiate a (2-step/4-step) RA procedure if at least one of the following events occurs:

(1) The UE has reported its location at a location point L0, and then the UE moves to another location point L1, where the distance (e.g., two-dimension (2D) or three-dimension (3D) distance) between the location points L0 and L1 is larger than a given (or pre-configured) distance threshold (e.g., in the unit of kilometers, meters, miles, etc.).
In some implementations, the UE may calculate or consider only the 2D distance between the location points L0 and L1. The distance threshold(s) may include any combinations of a first distance threshold for 2D distance and/or a second distance threshold for 3D distance.
In some implementations, the UE may report the 3D location information to the serving RAN. In some implementations, the UE may report the 2D location information to the serving RAN (e.g., based on serving RAN configuration). In some implementations, the UE may determine to report one or both of the 2D or 3D location information (e.g., based on certain triggering events and the associated distance threshold). In some implementations, the serving RAN may configure (e.g., via SIB or UE-specific RRC signaling) or instruct (e.g., via DCI or MAC CE) the UE to report either the 2D location information or the 3D location information. In some implementations, the UE may be pre-defined (e.g., according to the 3GPP technical specifications) to report the 2D or 3D location information to the serving RAN.

(2) The UE starts a timer upon transmitting the UE location information or the UE-specific TA information to the serving RAN, and when the timer expires, the UE may be triggered to transmit the UE location information or the UE-specific TA information to the serving RAN.
In some implementations, the UE may determine, upon an expiry of the timer, to skip reporting the UE location information or the UE-specific TA information if the UE location information or the UE-specific TA information has not changed (or has not changed too much, in comparison to a given threshold). In this case, the UE may still restart the timer for the next possible reporting.

In some implementations, a UE may report the UE location information or the UE-specific timing information via a UL UE-specific control signaling (e.g., a UEAssistance Information message).

In some implementations, a UE may report the UE location information during a (conditional) handover procedure. In some implementations, the UE may report the UE location information or the UE-specific TA information via an RRCReconfigurationComplete message.

In some implementations, a UE may or may not release, delete, or drop the stored UE location information or the UE-specific TA information if at least one of the following events occurs:

(1) The UE transitions to the RRC Inactive/Idle state (e.g., in the same RAT or upon the UE re-selecting to another RAT).
In some implementations, the UE may or may not release the pending or stored UE location information or UE-specific TA Information upon transitioning to RRC Inactive/idle state.

(2) The UE handovers to another cell.
In some implementations, the UE may or may not release the UE location information or the UE-specific TA information when the UE handovers to another cell. In some implementations, the handover event may be a conventional handover event, a conditional handover event, a Dual Active Protocol Stack (DAPS) handover event, or a lossless handover event. It should be noted that the handover event may be an intra-RAT handover event (e.g., from NR-RAT to NR-RAT), an inter-RAT handover event (e.g., from NR-RAT to E-UTRA), or a handover from an NTN cell to a TN cell.

It should be noted that, in some implementations, the stored UE location information or the UE-specific TA information may not be impacted by the (conditional) handover events indicated in this disclosure.

In some implementations, a UE may release the UE location information or the UE-specific TA information upon the MAC entity being reset. In some implementations, the stored UE location information or the UE-specific TA information may be kept or stored by the UE without being impacted by the reset of the MAC entity. In some implementations, the UE may release the UE location information or the UE-specific TA information upon the MAC entity being reset.

In some implementations, a UE may receive an instruction from the serving cell to initiate an RA procedure (e.g., via a DCI).

In some implementations, a UE may be configured to report the UE location information and/or the UE-specific TA information during the RA procedure (e.g., via the message-3 (MSG3) or message-5 (MSG5)).

2. Re-Start Condition when an RA Procedure is Running

In some implementations, a UE may be triggered to implement another RA procedure if an earlier RA procedure is already triggered by the UE (e.g., the UE receives another PDCCH order indicating the same RA preamble, as a previously received PDCCH order). In this case, the UE may not initiate another RA procedure, so that the UE may not change, update, or modify the UE location information and/or the UE-specific TA information previously reported by the UE (e.g., during the same RA procedure). Alternatively, the UE may initiate another RA procedure, so that the UE may change, update, or modify the UE location information and/or the UE-specific TA information previously reported by the UE (e.g., via the re-initiated RA procedure).

### 3. RA Procedure Triggered by Other Events

In some implementations, a UE may report the UE location information and/or the UE specific TA information during a Beam failure recovery procedure or a RAN Notification Area Update (RNAU) procedure (e.g., via an MSG5).

In some implementations, a UE may report the UE location information or the UE-specific TA information during the RNAU procedure (e.g., via an MSG3 or MSG5). In some implementations, the UE may report different versions or types of UE location information or UE-specific TA information based on the response message received via the MSG4. In some implementations, the UE may receive an RRCResume message via the MSG4 that instructs the UE to transition to the RRC Connected state, and when the security mechanism is already activated. In this case, the UE may report the UE location information or the UE-specific TA information with precise or more information in the MSG5 (e.g., an RRCResumeComplete message). In some implementations, the UE may receive an RRCSetup message via the MSG4 that instructs the UE to transition to the RRC Connected state, but the security mechanism may not be activated yet or the UE may need to re-setup its AS layer security with its serving RAN. In this case, the UE may report the UE location information or the UE-specific TA information with coarse or less information in the MSG5 (e.g., an RRCSetupComplete message).

In some implementations, the UE may receive an RR (Release message during the RNAU procedure. In this case, the UE may stay in the RRC Inactive state or transition to the RRC Idle state. It should be noted that, in some implementations, the UE may release or delete the stored UE location information or the UE-specific TA information when the UE transitions to the RRC Idle state or stays in the RRC Inactive state (e.g., during the RNAU procedure). In some implementations, the UE may still keep or store the UE location information or the UE-specific TA information even after the UE transitions to the RRC Idle state or stays in the RRC Inactive state (e.g., during the RNAU procedure).

### 4. Initial or Default HARQ State of the HARQ Procedure Initiated for an MSG3 Delivery

In some implementations, for the initial access, a UE may ignore the (pre-defined or re-configured) HARQ state configuration for the PUSCH transmission scheduled by a RAR.

In some implementations, a UE may apply a default HARQ state configuration (e.g., HARQ state=‘enabled’ or HARQ state A) for the PUSCH transmission scheduled by a RAR. In some implementations, all of the HARQ processes may be considered as legacy HARQ processes (e.g., configured with any HARQ state) before the UE receives an RRC message indicating the HARQ state associated with all of the HARQ processes.

In some implementations, a UE may be configured with a specific HARQ state (e.g., HARQ state A or HARQ state B) via the contention-free random access (CFRA) configuration.

In some implementations, a UE may be configured with a specific HARQ state (e.g., HARQ state A or HARQ state B) via the (conditional) handover instruction/command delivered by the target node (e.g., an NR NTN cell, NR gNB, or E-UTRA eNB). In addition, the source serving cell (e.g., an NR gNB or E-UTRA eNB) may forward the (conditional) handover instruction/command generated by the target node to the UEs via broadcasting control messages. In some implementations, a (conditional) handover instruction may be associated with a group of UEs. In some implementations, one or more UE groups may be defined by the serving RAN (e.g., based on the UE location or DL reference signal measurement reports of one or more cells). In addition, each UE group may be further associated with one UE Group ID and a (conditional) handover instruction. As such, the UE may determine to which UE group the UE belongs. In addition, the UE may determine to receive, decode, or implement a (conditional) handover instruction based on the associated UE Group ID.

In some implementations, for the non-initial access, a UE may not ignore the (pre-defined/re-configured) HARQ state configuration for the PUSCH transmission scheduled by a RAR message.

In some implementations, a UE may release the stored UE-specific timing information or the UE location information upon the MAC entity being reset. It should be noted that, for a UE configured with a DC configuration, the UE-specific timing information may be associated with only one MAC entity (e.g., the MAC entity associated with the SCG, or the MAC entity associated with the MCG). In this case, the UE may release the UE-specific timing information associated with the SCG, but may keep the UE-specific timing information associated with the MCG, if only the MAC entity associated with the SCG is reset. Otherwise, if only the MAC entity associated with the MCG is reset, the UE may release the UE-specific timing information associated with the MCG, but may keep the UE-specific timing information associated with SCG.

### HARQ Feedback Configuration and/or HARQ state Configuration for Specific Signaling, Purpose, or RB

### 1. SCell Activation/De-Activation Message

In some implementations, a UE may receive (at least) one MAC CE to activate or deactivate one or more secondary cell(s) configured to the UE. At least one of the primary cell (PCell), the Primary secondary cell (PSCell), or the secondary cell may be an NTN cell, and the UE may have reported to the serving RAN that it supports the HARQ feedback configuration and/or the HARQ state configuration. In addition, after receiving the ‘SCell activation/deactivation MAC CE’ from the serving RAN, the UE may need to reply to the serving cell or the serving RAN with the HARQ ACK information, as an ACK message for the SCell activation/deactivation configuration.

However, with the introduction of the NTN feature, in some implementations, the ‘SCell activation/deactivation MAC CE’ may (only) be associated or configured for one HARQ process that is associated with a HARQ state configuration being set to ‘enabled’ (which means that the UE is enabled to transmit the HARQ ACK/NACK information to the serving cell for the HARQ process). In some implementations, the ‘SCell activation/deactivation MAC CE’ may be associated or configured for one HARQ process that is associated with a HARQ state configuration being set to ‘disabled’ (which means that the UE is disabled to transmit the HARQ ACK/NACK information to the serving cell for the HARQ process). In some implementations, the ‘SCell activation/deactivation MAC CE’ may be associated or configured for one HARQ process that is not associated with a HARQ state (e.g., associated, instead, with a legacy HARQ process). In some implementations, the UE may be configured with any type of HARQ process (e.g., a HARQ process with the HARQ state configuration=‘enabled’ or ‘disabled’, or a legacy HARQ process) by the NW (e.g., via DCI, via RRC signaling, or via one or more equations pre-defined (e.g., according to the 3GPP technical specifications)).

In some implementations, the serving RAN (of the UE) may define a given type of HARQ process (e.g., with the HARQ state configuration=‘enabled’) if the serving RAN expects, wants, or configures the UE to report the HARQ ACK/NACK information (e.g., for one or more specific DL-control signaling).

In some implementations, the SRB may be (pre-)configured or (pre-)defined to be associated with only a subset of HARQ process types. For example, the SRB3/SRB2/SRB1/SRB0 may be (pre-)configured or (pre-)defined to be associated with only the HARQ processes that is associated with the HARQ state configuration=‘enabled’ and/or the legacy HARQ process. In other words, the UE may only (pre-)configure or (pre-)define (or be configured by the serving RAN) a HARQ process with a HARQ state configuration=‘enabled’ and/or a legacy HARQ process if the encoded MAC PDU or MAC data/TB includes any signaling from the SRB0/SRB1/SRB2/SRB3. That is, the UE may not configure the pending data from the SRB0/SRB1/SRB2/SRB3 to be transmitted via a HARQ process with a HARQ state configuration=‘disabled’.

### 2. MAC CE vs HARQ State in the DL Direction

In some implementations, a RAN may transmit a specific MAC CE via one or more HARQ processes associated with a specific HARQ feedback configuration at the UE side

In some implementations, a UE may be configured to enable or disable the transmission of one (or more) HARQ ACK/NACK information after receiving a specific MAC CE.

In some implementations, a UE may determine to transmit one or more HARQ ACK/NACK information for a specific MAC CE (e.g., a ‘Timing Advance Command MAC CE’) (only) via a HARQ process with the HARQ feedback configuration=‘enabled’ and/or a legacy HARQ process. In some implementations, the UE may decide to transmit one or more HARQ ACK/NACK information for a specific MAC CE when the UE, a frequency carrier, a MAC entity, or a BWP being configured with the HARQ feedback configuration=‘enabled’. In some implementations, the UE may determine to transmit one or more HARQ ACK/NACK information for a MAC CE (via one HARQ process) without considering the HARQ feedback configuration. In other words, the serving RAN may also expect the UE to report one or more HARQ ACK/NACK information related to a received TB if there is any MAC CE (or a specific MAC CE) transmitted within the TB, and the HARQ feedback configuration or the HARQ state configuration may be temporarily ignored. In some implementations, the UE may determine to transmit the HARQ ACK/NACK information for the received MAC CE (e.g., a ‘Timing Advance Command CE’) via a default HARQ state configuration or a default HARQ feedback configuration (e.g., a HARQ feedback/state configuration=‘enabled’), which may be (pre-)configured by the serving RAN, (pre-)defined (e.g. according to the 3GPP technical specifications), or (pre-)installed in the memory module of the UE.

In some implementations, a UE may determine not to transmit the HARQ ACK/NACK information for a specific MAC CE (e.g., a ‘Timing Advance Command MAC CE’) based on the HARQ feedback/state configuration of the HARQ process, which is applied by the serving RAN to transmit the concerned MAC CE. This situation may occur when the MAC CE is transmitted via a HARQ process with the HARQ feedback configuration=‘disabled’. In some implementations, the UE may determine not to transmit the HARQ ACK information for the received MAC CE (e.g., a ‘Timing Advance Command MAC CE’) when the UE, a frequency carrier, a MAC entity, or a BWP is configured with HARQ feedback/state configuration=‘disabled’. In some implementations, the UE may determine not to transmit the HARQ ACK/NACK information for the received MAC CE (e.g., a ‘Timing Advance Command CE’) via a default HARQ feedback/state configuration (e.g., a HARQ feedback/state configuration=‘disabled’), which may be (pre-)configured by the serving RAN, (pre-)defined (e.g., according to the 3GPP technical specifications), or (pre-)installed in the memory module of the UE.

In some implementations, a UE may determine to deliver one or more HARQ ACK/NACK information for any combinations of the following MAC CEs transmitted in one TB, including: (1) Timing Advance Command CE; (2) Absolute Timing Advance Command MAC CE; (3) DRX Command MAC CE; (4) Long DRX Command MAC CE; (5) SCell Activation/Deactivation MAC CEs; (6) Duplication Activation/Deactivation MAC CE; (7) SP CSI-RS/CSI-IM Resource Set Activation/Deactivation MAC CE; (8) Aperiodic CSI Trigger State Sub-selection MAC CE; (9) TCI States Activation/Deactivation for UE-specific PDSCH MAC CE; (10) TCI State Indication for UE-specific PDCCH MAC CE; (11) SP CSI reporting on PUCCH Activation/Deactivation MAC CE; (12) SP SRS Activation/Deactivation MAC CE; (13) PUCCH spatial relation Activation/Deactivation MAC CE; (14) SP ZP CSI-RS Resource Set Activation/Deactivation MAC CE; (15) Recommended bit rate MAC CE; (16) Timing Delta MAC CE; (17) Guard Symbols MAC CEs; (18) Enhanced TCI States Activation/Deactivation for UE-specific PDSCH MAC CE; (19) Enhanced PUCCH Spatial Relation Activation/Deactivation MAC CE; (20) Enhanced SP/AP SRS Spatial Relation Indication MAC CE; (21) SRS Pathloss Reference RS Update MAC CE; (22) PUSCH Pathloss Reference RS Update MAC CE; (23) Serving Cell Set based SRS Spatial Relation Indication MAC CE; and (24) Duplication RLC Activation/Deactivation MAC CE. The types of MAC CEs may be defined, according to the 3GPP technical specifications (e.g., TS 36.321 or TS 38.321).

In some implementations, a UE may be configured with one or more HARQ state configurations (e.g., set to ‘enabled’ or ‘disabled’) associated with a HARQ process. In addition, the UE may determine whether the HARQ state configuration may or may not impact the UE in expecting the HARQ ACK/NACK information in the DL direction, after the UE has transmitted a TB which includes any combination of the following MAC CEs: (1) BFR MAC CE; (2) LBT failure MAC CE; (3) Multiple Entry Configured Grant Confirmation MAC CE; (4) Sidelink Buffer Status Report MAC CEs; (5) Sidelink Configured Grant Confirmation MAC CE; (6) Sidelink CSI Reporting MAC CE; and (7) SP Positioning SRS Activation/Deactivation MAC CE.

3. BWP, Cell, Frequency Carrier, or Cell Group Selection for Specific Control Signaling or MAC CE Exchange between the UE and the Serving RAN

In some implementations, a UE or a serving RAN may determine the target BWP, operation Cell, frequency carrier, cell group (e.g., MCG/SCG), or HARQ process to transmit signaling (e.g., in the DL or UL direction) while different HARQ feedback configurations and/or HARQ state configurations are configured on different BWPs, cells, frequencies, cell groups, or HARQ processes. For example, the UE may be configured to transmit one specific MAC CE or RRC signaling via one or more HARQ processes with the HARQ feedback configuration=‘enabled’ or the HARQ state configuration=‘enabled’. In this case, the UE may select a HARQ process with the HARQ feedback configuration or the HARQ state configuration=‘enabled’, or select a cell with the HARQ feedback configuration or the HARQ state configuration=‘enabled’, or select a frequency carrier (e.g., special cell or secondary cell) with the HARQ feedback configuration or the HARQ state configuration=‘enabled’, or select a cell group (or the network node associated with the cell group, such as the master node associated the MCG or the SCG) to transmit the specific signaling (e.g., RRC signaling or MAC CE). In some implementations, the selected cell, cell group, or frequency carrier may be implemented by or on a TN, and the UE or the serving RAN may expect to report or wait for the HARQ ACK/NACK information (which is relayed, forwarded, or transmitted via the TN) only as a legacy HARQ process (and, therefore, only as a legacy RAN/UE implementation) without considering the impact of the HARQ feedback configuration or the HARQ state configuration.

In some implementations, in a DC scenario, a UE may transmit or receive RRC signaling(s) (which is for the NTN) via the relaying of a TN. For example, at the UE side, the NTN may be configured as an MCG and the TN may be configured as an SCG. In addition, the secondary PCell (e.g., a cellular BS in the TN) may assist the UE or the master node with relaying the specific control signaling (e.g., via SRB3) or MAC CE. In some implementations, the RRC signaling (or MAC CE(s)) exchanged between the UE and the SCG may have mutual impacts on both the MCG and the SCG, and the serving RAN and the UE may exchange control signaling or MAC CE(s) with expected HARQ ACK/NACK information.

It should be noted that, in this disclosure, the frequency carriers in the UL direction may include a normal uplink (NUL) carrier and a supplementary uplink (SUL) carrier.

### Further Enhancements for NTN Network Management

### 1. Tracking Area Code (TAC) Association

In the NTN network management, there may be a maximum of 12 TACs per NR NTN cell in the same PLMN or in different PLMNs

In some implementations, each TAC broadcast by an NTN cell may be associated with (e.g., explicitly indicated by the camped cell or the serving cell) one NW identity which may also be broadcast in a plmn-IdentityList or a NPN-IdentityList by the same NTN cell.

In some implementations, each TAC broadcast by an NTN cell may be associated with (e.g., explicitly indicated by the camped cell or the serving cell) one NW index, and each NW index may be (uniquely) associated with one NW identity broadcast in a plmn-IdentityList or a NPN-IdentityList. In some implementations, the NW index may be (implicitly) determined by the NW or the UE based on the sequence of the plmn-Identity included in the plmn-IdentityList (or based on the sequence of the NPN-Identity included in the NPN-IdentityList). In some implementations, the TAC broadcast by the serving cell may not be explicitly configured with one NW identity broadcast by the serving cell. Instead, in this case, the UE may determine that such TAC is implicitly mapped to one specific NW identity (e.g., the first plmn-Identity included in the plmn-IdentityList or the first NPN-Identity included in the NPN-IdentityList).

### 2. RATs or CNs Supported in one NW and the Co-Existence Issue

In some implementations, one NW (e.g., one PLMN, Standalone Non-Public Network (SNPN), or Public Network Integrated NPN (PNI-NPN)) may support one or more RATs (e.g., NR, E-UTRA, and NB-IoT) and one or more core networks (e.g., 5GC and Evolved Packet Core (EPC)). An E-UTRA UE or a UE registered with an EPC may acquire a list of TACs associated with its registered NW via the SIB1 broadcast by the serving cell. However, a co-existence issue may occur if the UE does not support NTN (which means that the UE may not be able to support multiple TACs reception). In this case, the UE (e.g., the RRC entity of the UE) may store only one TAC and then check whether the stored TAC is broadcast by a detected cell (e.g., during a cell (re)selection procedure). If the stored TAC is not broadcast by a camped cell, the UE may forward the received TAC list to the upper layer (e.g., the NAS layer at the UE side), or the UE may report a condition of ‘moving out of the stored TA (or a registered TA)’ to the NAS layer without delivering the received TAC list to the upper layer. In some implementations, a UE not supporting the TAC list reception may not select, or camp on, a cell which broadcasts a TAC list.

In some implementations, a UE may not determine a cell to be a suitable or acceptable cell if the UE monitors a TAC list in the SIB1 broadcast by the cell and the UE does not support NTN or TAC list reception. In some implementations, the UE may determine a cell to be a suitable or acceptable cell if the UE monitors a TAC list in the SIB1 broadcast by the cell and the UE does support NTN or TAC list reception).

It should be noted that although the implementations in this disclosure are generally addressed with respect to the 3GPP NR architecture, the proposed mechanisms may also be applicable to other RATs, such as E-UTRA, Wi-Fi, IoT, MTC, etc., and they should not be limited thereto.

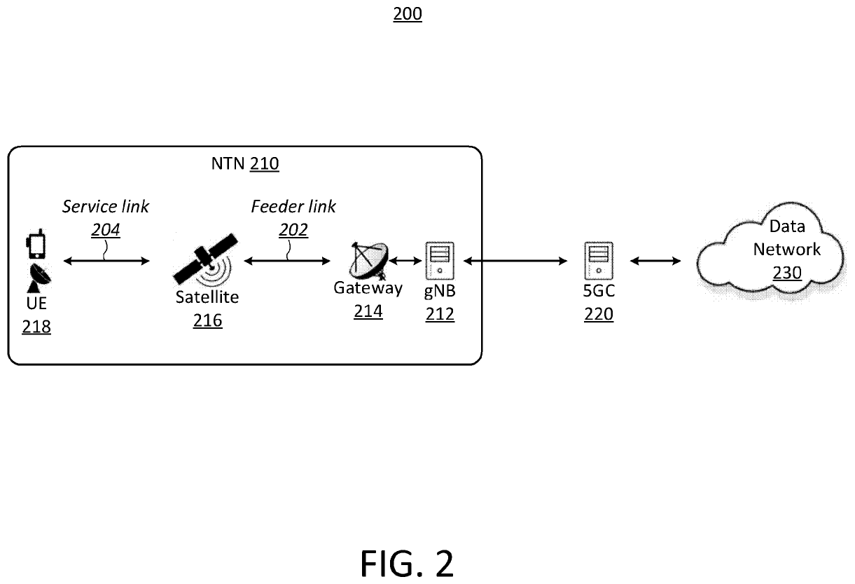

FIG. 2 is a diagram 200 illustrating an NTN, according to an example implementation of the present disclosure. As illustrated in FIG. 2, an NTN 210 may include a gNB 212, a GW 214, a satellite 216, and a UE 218.

A ground or earth station may include a Sat-gateway (e.g., the GW 214) and a TTCM unit. One or several Sat-gateways may be attached to a BS BBU or a gNB (e.g., the gNB 212) that connects the NTN to a core network (e.g., the 5GC 220) or an application server. Through the 5GC 220, the NTN 210 may be further connected to an external or public network (e.g., the data network 230). The BS BBU or the gNB 212 may be close to Sat-gateways (e.g., either co-located or a few kilometers apart), and antenna diversity may be required depending on geographical location and feeder-link frequency band.

The satellite 216 may be a GEO or a non-GEO satellite. The satellite 216 may be part of a satellite constellation to ensure service continuity and may be served successively by one or several Sat-gateways. A satellite constellation controller may provide each BS with satellite system data (ephemeris, satellite position, and velocity, etc.). A feeder link 202 may refer to a radio link conveying information for a satellite mobile service between a Sat-gateway (e.g., the GW 214) and the satellite 216. A service link 204 may refer to a radio link between the UE 218 and the satellite 216.

The satellite 216 may implement a transparent payload. The transparent payload may require processing, including RF filtering, frequency conversion, and amplification, to be performed on-board the satellite 216. Hence, the waveform signal repeated by the payload is unchanged except for frequency translation and transmission power. The satellite 216 may typically generate several spot-beams over a given service area bounded by its FoV or footprint. The footprints of the spot-beams may typically be of an elliptic shape.

The UE 218 may be a GNSS-capable UE, which may be a handheld device (e.g., an NR or LTE smartphone), an IoT device (e.g., an NB-IoT or eMTC device), a VSAT, or a moving platform (e.g., an aircraft, a vessel, and a building-mounted device).

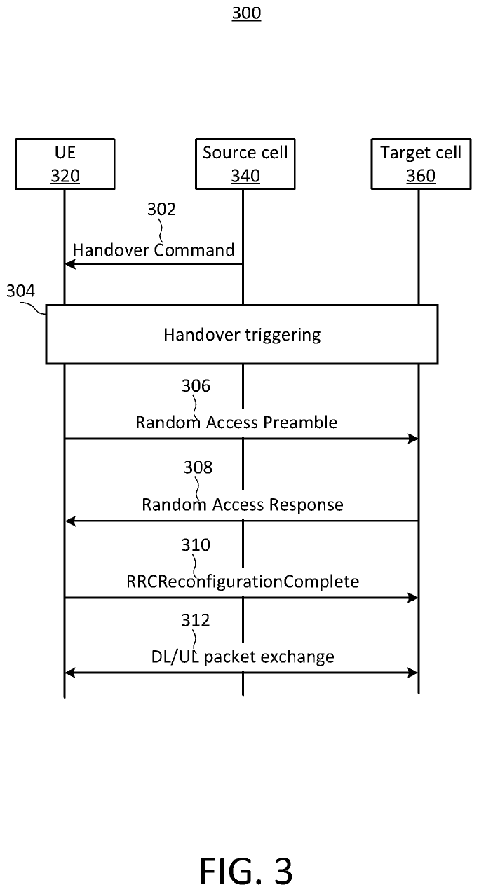

FIG. 3 is a message sequence chart illustrating a handover procedure 300 performed via a 4-step RA procedure, according to an example implementation of the present disclosure. In action 302, the UE 320 may receive one or more handover commands from the source cell 340, which is also one of the UE's serving cells. The source cell 340 may deliver the handover command to one or more UEs via a broadcasting (e.g., via a group-based PDCCH message, broadcasting system information, etc.) or via UE-specific control signaling. In some implementations, the proposed HARQ feedback configuration and/or HARQ state configuration may also be transmitted in the handover command. In some implementations, the handover command may be further associated with one or more candidate cells (e.g., the target cell 360) as the candidate cells for the subsequent handover procedure. In action 304, after receiving the handover command, the UE may trigger a (conditional) handover procedure. In some implementations, it is the UE 320 to select a target cell (among the one or more candidate cells provided in the handover command). In some implementations, it is the source cell 340 to configure or indicate the target cell 360 to the UE 320 via the handover command. In some implementations, it is the UE 320 to determine which types of the handover procedure (e.g., via a 2-step RA (also known as a contention-free RA (CFRA)) procedure, a 4-step RA (also known as a contention-based RA (CBRA)) procedure, or a RACH-less procedure). In some implementations, the source cell 340 may provide one or more control parameters for the UE 320 to determine the type of the subsequent triggered handover procedure (e.g., DL-RSRP value threshold, distance threshold in comparison with a reference point provided by the source cell 340). In some implementations, the source cell 340 may configure or indicate the type of the subsequent handover procedure to the UE 320 directly (e.g., via a 2-step RA procedure, a 4-step RA procedure, or a RACH-less procedure), or via the handover command directly.

In action 306, after the UE 320 determines to trigger a handover procedure, the UE 320 may transmit a random access preamble (RAP) to the target cell 360 (e.g., a candidate cell selected as the target cell in the following handover procedure). In action 308, the target cell 360 may reply a random access response (RAR) message to the UE 320. In the RAR message, the target cell 360 may further indicate a UL grant to the UE 320 for the UE 320 to transmit the subsequent signaling. In action 310, after receiving the RAR message, the UE 320 may transmit an RRCReconfigurationComplete message to the target cell 360. In some implementations, the UE 320 may apply the HARQ state configuration, which may be configured by the source cell 340 in the handover command, for the UL HARQ process associated with the RRCReconfigurationComplete message transmission. The handover procedure may be considered as successfully completed when the target cell 360 receives the RRCReconfigurationComplete message successfully. After that, in action 312, the UE 320 and the target cell 360 may perform the DL/UL packet exchange based on the HARQ feedback configuration and/or the HARQ state configuration broadcast by the handover command.

In some implementations, a part of the content in the handover command received in action 302 (e.g., which are related to the target cell 360) may be determined by the target cell 360. The target cell 360 and the source cell 340 may negotiate the content of the handover command via a wired or wireless backhaul connection.

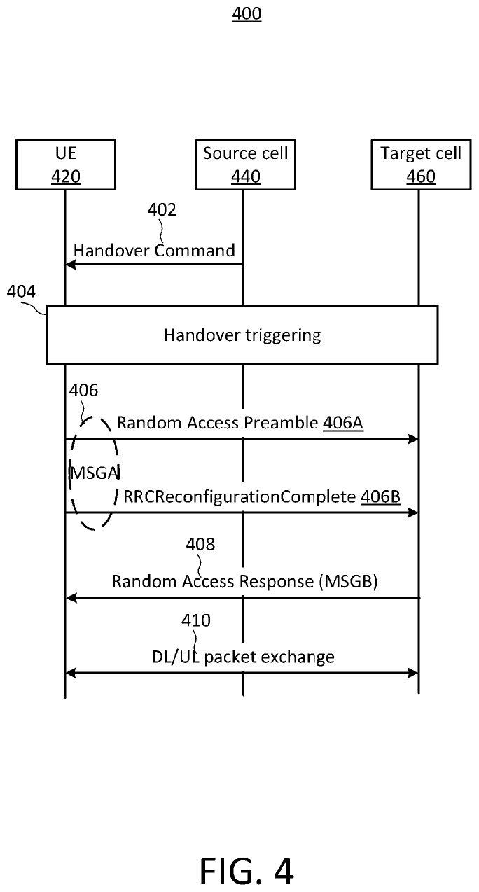

FIG. 4 is a message sequence chart illustrating a handover procedure 400 performed via a 2-step RA procedure, according to an example implementation of the present disclosure. In action 406, the UE 420 may transmit both the e random access preamble 402A and the RRCReconfigurationComplete message 402B in a message (e.g., via an MSGA transmission). In some implementations, the UE 420 may implement the HARQ re-transmission of the MSGA by applying the pre-configured HARQ state configuration (which may be pre-configured in the handover command received in action 402). In some implementations, the pre-configured HARQ state configuration may not be applied to the MSGA transmission, which may include a preamble and a PUSCH transmission, as shown in FIG. 4. In action 408, after the MSGA transmission during the 2-step RA procedure, the target cell 460 may reply an MSGB (e.g., a random access response (RAR) message) to the UE 420 and then the 2-step RA procedure or the handover procedure may be completed successfully. In some implementations, both of the UE 420 and the target cell 460 may also perform the MSGB transmission (by the target cell 605)/reception (by the UE 601) based on the HARQ feedback configuration pre-configured in the handover command received in action 402. In some implementations, the pre-configured HARQ feedback configuration may not be applied to the MSGB transmission/reception. In the case where the pre-configured HARQ state configuration is not to be applied to the MSGB transmission/reception), the UE 420 or the target cell 460 may apply the pre-configured HARQ feedback configuration or HARQ state configuration for the DL/UL packet exchange in action 410.

It should be noted that, in some implementations, the UE 420 may fallback from a 2-step RA procedure to a 4-step RA procedure. In some implementations, the fallback mechanism may also be pre-configured via the handover command received in action 402. In some implementations, the pre-configured HARQ feedback configuration or the pre-configured HARQ state configuration may also be applied to a 4-state RA procedure which may be a fallback from a 2-step RA procedure. In some implementations, a part of the content in the handover command received in action 402 (e.g., which are related to the target cell 460) may be determined by the target cell 460. The target cell 460 and the source cell 440 may negotiate the content of the handover command via a wired or wireless backhaul connection.

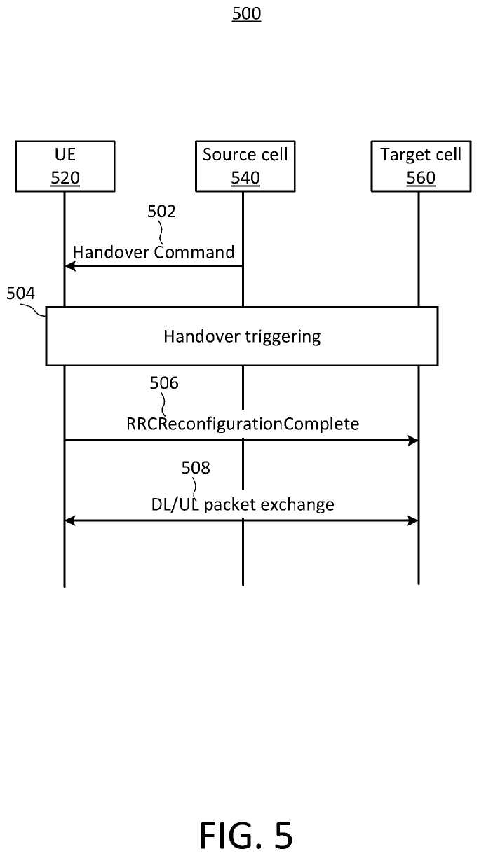

FIG. 5 is a message sequence chart illustrating a handover procedure 500 performed via a RACH-less handover procedure, according to an example implementation of the present disclosure. In action 502, the source cell 540 may configure or instruct a RACH-less handover procedure to the UE 520 via a handover command (e.g., via group-PDCCH delivery or broadcasting system information). In action 504, the UE 520 may determine to initiate a RACH-less handover procedure associated with the selected target cell 560 (which may be one of the candidate cells provided by the source cell 540 via the handover command). In action 506, the UE 520 may transmit an RRCReconfigurationComplete message to the target cell 560. In some implementations, the UE 520 may perform the transmission of the RRCReconfigurationComplete message based on a pre-configured HARQ state configuration (e.g., pre-configured in the handover command). In action 508, the UE 520 and the target cell 560 may apply the pre-configured HARQ feedback configuration or the pre-configured HARQ state configuration for the DL/UL packet exchange.

In some implementations, a part of the content in the handover command received in action 502 (e.g., which are related to the target cell 560) may be determined by the target cell 560. The target cell 560 and the source cell 540 may negotiate the content of the handover command via a wired or wireless backhaul connection. In some additional implementations, in the handover command 502, the target cell 560 may pre-configure (e.g., via the forwarding of the source cell 540) the UL grant(s) for the UE 520 to transmit the RRCReconfigurationComplete message in action 506 (and the downlink assignments/UL grants for the DL/UL packet exchange).

In some implementations, a UE (e.g., the UE 320/420/520) may fallback to an RRC connection re-establishment procedure if the ongoing (conditional/RACH-less) handover procedure fails. In this case, the UE may perform the cell (re)selection procedure to find a campable/suitable cell to re-establish the RRC connection between the UE and the serving RAN (e.g., the source cell 340/440/540, the target cell 360/460/560, or other cells in the serving RAN). In some implementations, the UE may also apply the pre-configured HARQ feedback configuration or the pre-configured HARQ state configuration during the RRC connection re-establishment procedure (e.g., while the camped cell is also one of the candidate cells provided in the handover command received in action 302/402/502).

In some implementations, the UE may transmit an RRCReestablishmentRequest message to the candidate cell based on the pre-configured UL HARQ state configuration. In some implementations, the UE may not transmit the RRCReestablishmentRequest message based on the pre-configured UL HARQ state configuration (e.g., the RRCReestablishmentRequest message transmission may be associated with a pre-defined default setting with HARQ state A/B). In some implementations, the candidate cell may reply an RRCReestablishment message to the UE to re-establish the RRC connection with the UE. In some implementations, the RRCReestablishment message may be associated with a pre-configured DL HARQ feedback configuration (e.g., pre-configured via the handover command received in action 302/402/502). In some implementations, the candidate cell may not transmit the RRCReestablishment message based on the pre-configured DL HARQ feedback configuration (e.g., the RRCReestablishment message transmission may be associated with a pre-defined default setting with HARQ feedback=‘enabled’ or ‘disabled’).

It should be noted that, besides the RRCReestablishment message, the candidate cell may also reply an RR (Release or RRCSetup message to the UE and the proposed mechanisms may also be applied to these RRC messages. After receiving the RRCReestablishment message from the serving RAN, the UE may reply an RRCReestablishmentComplete message to the candidate cell. In some implementations, the RRCReestablishmentComplete message may be associated with a pre-configured UL HARQ state configuration (e.g., pre-configured via the handover command received in acion 302/402/502). In some implementations, the UE may not transmit the RRCReestablishmentComplete message to the candidate cell based on the pre-configured UL HARQ state configuration (e.g., the RRCReestablishmentComplete message transmission may be associated with a pre-defined default setting with HARQ state=A/B). It should be noted that, in some implementations, the UE may re-select to the original source cell (e.g., source cell 340/440/540) and then initiate the RRC connection re-establishment procedure with the original source cell. In this case, the UE and the source cell may perform the RRC connection re-establishment procedure (e.g., including the transmission and reception of an RRCReestablishmentRequest message, an RRCReestablishment message, and/or an RRCReestablishmentComplete message) based on the original HARQ feedback configuration or the original HARQ state configuration associated with the source cell and the UE.

It should be noted that the UE (e.g., the UE 320/420/520) may be an NR UE or an E-UTRA UE. Each of the source cell (e.g., the source cell 340/440/540) and the target cell (e.g., the target cell 360/460/560) may be a TN cell or an NTN cell. In some implementations, each of the source cells (e.g., the source cell 340/440/540) and the target cell (e.g., the target cell 360/460/560) may be an NR cell or an E-UTRA cell, and the broadcast handover command in action 302/402/502 and the handover triggering action (e.g., action 304/404/504) may be provided via the E-UTRA protocol or NR protocol.

In some implementations, the UE may initiate a CFRA procedure to initialize the airlink connection with the selected target cell. In some implementations, the UE may initiate a CBRA procedure to initialize the airlink connection with the selected target cell. In some other implementations, the UE may initiate a RACH-less handover procedure to initialize the airlink connection with the selected target cell. The UE may be triggered to implement the CFRA/CBRA/RACH-less RA procedure for a handover also based on the configurations or instructions received from the original source cell. In some implementations, the source cell may further instruct, via the handover command, the type of RA procedure (e.g., CFRA/CBRA/RACH-less) through which the UE is allowed or enabled to perform the handover procedure. In addition, the handover command (e.g., an instruction to apply CFRA/CBRA/RACH-less for handover) may be transmitted by the source cell via broadcasting control signaling (e.g., via broadcasting system information, such as SIB1, SIB19) or group-cast control signaling (e.g., via groupcast-PDCCH) or UE-specific control signaling (e.g., RR (Reconfiguration message with an IE ‘reconfigurationwithsync’).

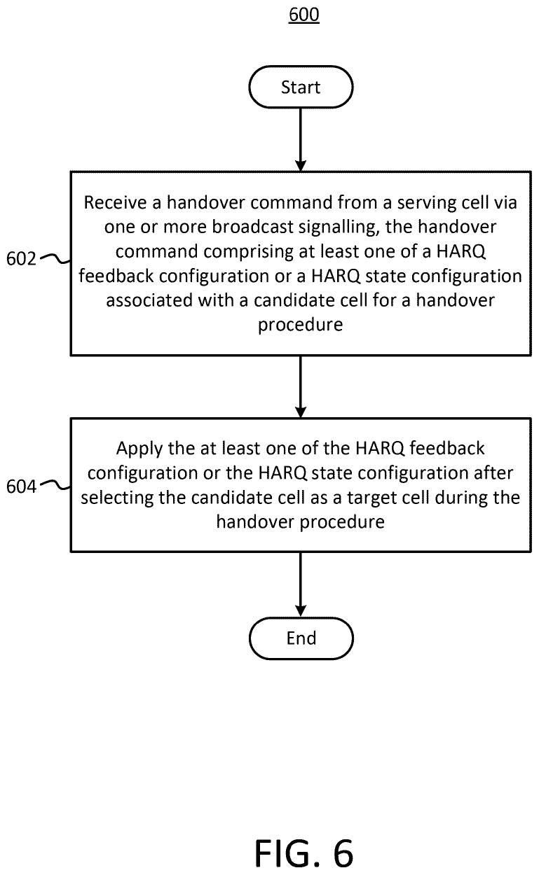

FIG. 6 is a flowchart illustrating a method/process 600 performed by a UE for controlling a HARQ process, according to an example implementation of the present disclosure. In action 602, the process 600 may start by receiving a handover command from a serving cell via broadcast signalling, the handover command including at least one of a HARQ feedback configuration or a HARQ state configuration associated with a candidate cell for a handover procedure. In action 604, the process 600 may apply the at least one of the HARQ feedback configuration or the HARQ state configuration after selecting the candidate cell, as a target cell, during the handover procedure. The process 600 may then end.

In some implementations, the at least one of the HARQ feedback configuration or the HARQ state configuration may be applied upon, or after, transmitting an RRC reconfiguration complete message to the candidate cell.

In some implementations, the HARQ feedback configuration may include a bit string associated with multiple HARQ processes of a HARQ entity associated with the candidate cell, and each bit of the bit string may be used to enable or disable a DL HARQ feedback sent in a UL direction for a respective one of the multiple HARQ processes.

In some implementations, the HARQ state configuration may include a bit string associated with multiple HARQ processes of a HARQ entity associated with the candidate cell, each bit of the bit string may be used to set a HARQ state for a respective one of the multiple HARQ processes, and the HARQ state may indicate whether a reception of an UL retransmission grant for the respective one of the multiple HARQ processes is enabled or disabled.

In some implementations, one or more HARQ processes of the HARQ entity may be activated by the serving cell via the broadcast signalling. The broadcast signalling may include system information, and the at least one of the HARQ feedback configuration or the HARQ state configuration may be applied only to the activated one or more HARQ processes associated with the target cell.

In some implementations, each of the serving cell and the candidate cell may be an NTN cell or a TN cell. The TN cell may include an E-UTRA cell or an NR cell, and the handover command may be a conditional handover command and the handover procedure may be a conditional handover procedure.

In some implementations, the UE may determine a default HARQ feedback configuration, as enabled, for each activated HARQ process in a case that the handover command does not include the HARQ feedback configuration associated with the candidate cell. The UE may also determine a default HARQ state configuration, as enabled, for each activated HARQ process in a case that the handover command does not include the HARQ state configuration associated with the candidate cell.

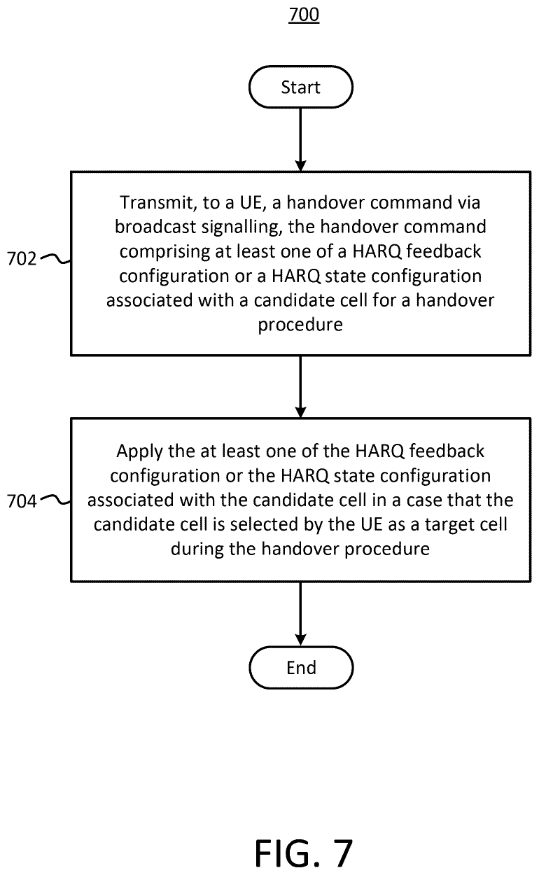

FIG. 7 is a flowchart illustrating a method/process 700 performed by a BS for controlling a HARQ process, according to an example implementation of the present disclosure. In action 702, the process 700 may start by transmitting, to a UE, a handover command via broadcast signalling, the handover command including at least one of a HARQ feedback configuration or a HARQ state configuration associated with a candidate cell for a handover procedure. In action 704, the process 700 may apply the at least one of the HARQ feedback configuration or the HARQ state configuration associated with the candidate cell in a case that the candidate cell is selected by the UE, as a target cell, during the handover procedure. The process 700 may then end.

In some implementations, the at least one of the HARQ feedback configuration or the HARQ state configuration may be applied upon, or after, receiving an RRC reconfiguration complete message from the UE.

In some implementations, the HARQ feedback configuration may include a bit string associated with multiple HARQ processes of a HARQ entity associated with the target cell, and each bit of the bit string may be used to enable or disable a DL HARQ feedback sent in a UL direction for a respective one of the multiple HARQ processes.

In some implementations, the HARQ state configuration may include a bit string associated with multiple HARQ processes of a HARQ entity associated with the target cell, each bit of the bit string may be used to set a HARQ state for a respective one of the multiple HARQ processes, and the HARQ state may indicate whether a reception of an UL retransmission grant for the respective one of the multiple HARQ processes is enabled or disabled.

In some implementations, one or more HARQ processes of the HARQ entity may be activated by a serving cell via the broadcast signalling, the broadcast signalling may include system information, and the at least one of the HARQ feedback configuration or the HARQ state configuration may be applied only to the activated one or more HARQ processes associated with the target cell.

In some implementations, the candidate cell may be an NTN cell or a TN cell, the TN cell may include an E-UTRA cell or an NR cell, and the handover command may be a conditional handover command and the handover procedure may be a conditional handover procedure.

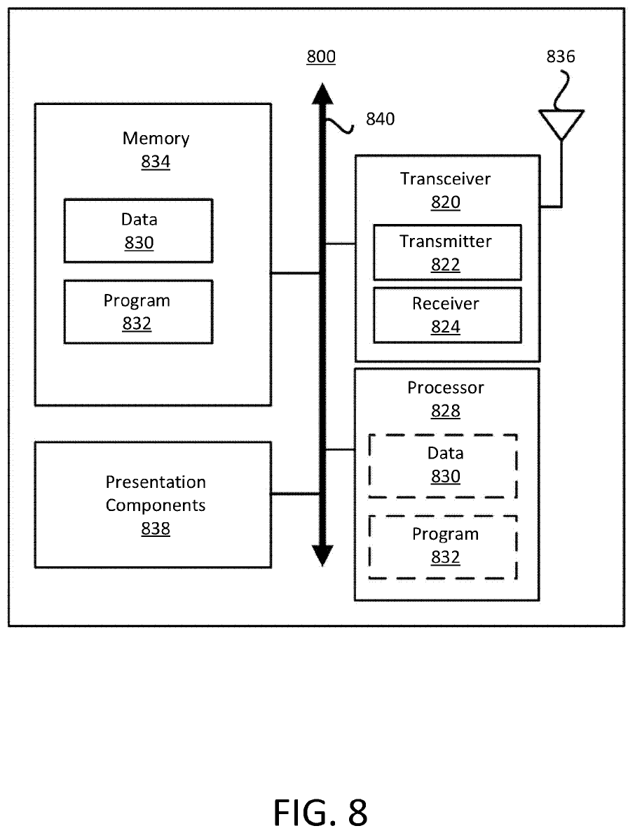

FIG. 8 is a block diagram illustrating a node 800 for wireless communication in accordance with various aspects of the present disclosure. As illustrated in FIG. 8, a node 800 may include a transceiver 820, a processor 828, a memory 834, one or more presentation components 838, and at least one antenna 836. The node 800 may also include an RF spectrum band module, a BS/UE communications module, a network communications module, and a system communications management module, Input/Output (I/O) ports, I/O components, and a power supply (not illustrated in FIG. 5).

Each of the components may directly or indirectly communicate with each other over one or more buses 840. The node 800 may be a UE or a BS that performs various functions disclosed with reference to FIGS. 1 through 7.

The transceiver 820 has a transmitter 822 (e.g., transmitting/transmission circuitry) and a receiver 824 (e.g., receiving/reception circuitry) and may be configured to transmit and/or receive time and/or frequency resource partitioning information. The transceiver 820 may be configured to transmit in different types of subframes and slots including but not limited to usable, non-usable, and flexibly usable subframes and slot formats. The transceiver 820 may be configured to receive data and control channels.

The node 800 may include a variety of computer-readable media. Computer-readable media may be any available media that may be accessed by the node 800 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include random access memory (RAM), read-only memory (ROM), erasable-programmable ROM (EPROM), electrically-erasable-programmable ROM (EEPROM), flash memory (or other memory technology), compact-disc-ROM (CD-ROM), digital versatile disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 834 may include computer-storage media in the form of volatile and/or non-volatile memory. The memory 834 may be removable, non-removable, or a combination thereof. Example memory may include solid-state memory, hard drives, optical-disc drives, etc. As illustrated in FIG. 8, the memory 834 may store a computer-readable and/or computer-executable program 832 (e.g., software codes) that are configured to, when executed, cause the processor 828 to perform various functions disclosed herein, for example, with reference to FIGS. 1 through 7. Alternatively, the program 832 may not be directly executable by the processor 828 but may be configured to cause the node 800 (e.g., when compiled and executed) to perform various functions disclosed herein.

The processor 828 (e.g., having processing circuitry) may include an intelligent hardware device, e.g., a central processing unit (CPU), a microcontroller, an ASIC, etc. The processor 828 may include memory. The processor 828 may process the data 830 and the program 832 received from the memory 834, and information transmitted and received via the transceiver 820, the baseband communications module, and/or the network communications module. The processor 828 may also process information to send to the transceiver 820 for transmission via the antenna 836 to the network communications module for transmission to a CN.

One or more presentation components 838 may present data indications to a person or another device. Examples of presentation components 838 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed, and many rearrangements, modifications, and substitutions are possible without departing from the scope of the present disclosure.

1. A method performed by a user equipment (UE) for controlling a hybrid automatic repeat request (HARQ) process, the method comprising:
receiving a handover command from a serving cell via broadcast signalling, the handover command comprising at least one of a HARQ feedback configuration or a HARQ state configuration associated with a candidate cell for a handover procedure; and
applying the at least one of the HARQ feedback configuration or the HARQ state configuration after selecting the candidate cell as a target cell during the handover procedure.

2. The method of claim 1, wherein the at least one of the HARQ feedback configuration or the HARQ state configuration is applied upon or after transmitting a radio resource control (RRC) reconfiguration complete message to the candidate cell.

3. The method of claim 1, wherein:
the HARQ feedback configuration comprises a bit string associated with a plurality of HARQ processes of a HARQ entity associated with the candidate cell, and
each bit of the bit string is used to enable or disable a downlink (DL) HARQ feedback sent in an uplink (UL) direction for a respective one of the plurality of HARQ processes.

4. The method of claim 1, wherein:
the HARQ state configuration comprises a bit string associated with a plurality of HARQ processes of a HARQ entity associated with the candidate cell,
each bit of the bit string is used to set a HARQ state for a respective one of the plurality of HARQ processes; and
the HARQ state indicates whether a reception of an uplink (UL) retransmission grant for the respective one of the plurality of HARQ processes is enabled or disabled.

5. The method of claim 1, wherein:
one or more HARQ processes of a HARQ entity associated with the target cell are activated by the serving cell via the broadcast signalling, the broadcast signalling comprising system information; and
the at least one of the HARQ feedback configuration or the HARQ state configuration is applied only to the activated one or more HARQ processes associated with the target cell.

6. The method of claim 1, wherein:
each of the serving cell and the candidate cell is a non-terrestrial network (NTN) cell or a terrestrial network (TN) cell,
the TN cell comprises an evolved universal terrestrial radio access (E-UTRA) cell or a new radio (NR) cell,
the handover command is a conditional handover command, and
the handover procedure is a conditional handover procedure.

7. The method of claim 1, further comprising:
determining a default HARQ feedback configuration as enabled for each activated HARQ process of a plurality of HARQ processes of a HARQ entity associated with the candidate cell in a case that the handover command does not comprise the HARQ feedback configuration associated with the candidate cell; and
determining a default HARQ state configuration as enabled for each activated HARQ process in a case that the handover command does not comprise the HARQ state configuration associated with the candidate cell.

8. A user equipment (UE) for controlling a hybrid automatic repeat request (HARQ) process, the UE comprising:
at least one processor; and
at least one non-transitory computer-readable medium coupled to the at least one processor and storing one or more computer-executable instructions that, when executed by the at least one processor, cause the UE to:
receive a handover command from a serving cell via broadcast signalling, the handover command comprising at least one of a HARQ feedback configuration or a HARQ state configuration associated with a candidate cell for a handover procedure; and
apply the at least one of the HARQ feedback configuration or the HARQ state configuration after selecting the candidate cell as a target cell during the handover procedure.

9. The UE of claim 8, wherein the at least one of the HARQ feedback configuration or the HARQ state configuration is applied upon or after transmitting a radio resource control (RRC) reconfiguration complete message to the candidate cell.

10. The UE of claim 8, wherein:
the HARQ feedback configuration comprises a bit string associated with a plurality of HARQ processes of a HARQ entity associated with the candidate cell, and
each bit of the bit string is used to enable or disable a downlink (DL) HARQ feedback sent in an uplink (UL) direction for a respective one of the plurality of HARQ processes.

11. The UE of claim 8, wherein:
the HARQ state configuration comprises a bit string associated with a plurality of HARQ processes of a HARQ entity associated with the candidate cell,
each bit of the bit string is used to set a HARQ state for a respective one of the plurality of HARQ processes; and
the HARQ state indicates whether a reception of an uplink (UL) retransmission grant for the respective one of the plurality of HARQ processes is enabled or disabled.

12. The UE of claim 8, wherein:
one or more HARQ processes of a HARQ entity associated with the target cell are activated by the serving cell via the broadcast signalling, the broadcast signalling comprising system information; and, and
the at least one of the HARQ feedback configuration or the HARQ state configuration is applied only to the activated one or more HARQ processes associated with the target cell.

13. The UE of claim 8, wherein:
each of the serving cell and the candidate cell is a non-terrestrial network (NTN) cell or a terrestrial network (TN) cell,
the TN cell comprises an evolved universal terrestrial radio access (E-UTRA) cell or a new radio (NR) cell,
the handover command is a conditional handover command, and
the handover procedure is a conditional handover procedure.

14. The UE of claim 8, wherein the one or more computer-executable instructions, when executed by the at least one processor, further cause the UE to:
determine a default HARQ feedback configuration as enabled for each activated HARQ process of a plurality of HARQ processes of a HARQ entity associated with the candidate cell in a case that the handover command does not comprise the HARQ feedback configuration associated with the candidate cell; and
determine a default HARQ state configuration as enabled for each activated HARQ process in a case that the handover command does not comprise the HARQ state configuration associated with the candidate cell.

15. A base station (BS) for controlling a hybrid automatic repeat request (HARQ) process, the BS comprising:
at least one processor; and
at least one non-transitory computer-readable medium coupled to the at least one processor and storing one or more computer-executable instructions that, when executed by the at least one processor, cause the BS to:
transmit, via a serving cell, to a user equipment (UE), a handover command via broadcast signalling, the handover command comprising at least one of a HARQ feedback configuration or a HARQ state configuration associated with a candidate cell for a handover procedure; and
apply the at least one of the HARQ feedback configuration or the HARQ state configuration associated with the candidate cell in a case that the candidate cell is selected by the UE as a target cell during the handover procedure.

16. The BS of claim 15, wherein the at least one of the HARQ feedback configuration or the HARQ state configuration is applied upon or after receiving a radio resource control (RRC) reconfiguration complete message from the UE.

17. The BS of claim 15, wherein:
the HARQ feedback configuration comprises a bit string associated with a plurality of HARQ processes of a HARQ entity associated with the candidate cell, and
each bit of the bit string is used to enable or disable a downlink (DL) HARQ feedback sent in an uplink (UL) direction for a respective one of the plurality of HARQ processes.

18. The BS of claim 15, wherein:
the HARQ state configuration comprises a bit string associated with a plurality of HARQ processes of a HARQ entity associated with the candidate cell,
each bit of the bit string is used to set a HARQ state for a respective one of the plurality of HARQ processes; and, and
the HARQ state indicates whether a reception of an uplink (UL) retransmission grant for the respective one of the plurality of HARQ processes is enabled or disabled.

19. The BS of claim 15, wherein:
one or more HARQ processes of HARQ entity associated with the target cell are activated by the serving cell via the broadcast signalling, the broadcast signalling comprising system information; and
the at least one of the HARQ feedback configuration or the HARQ state configuration is applied only to the activated one or more HARQ processes associated with the target cell.

20. The BS of claim 15, wherein:
each of the serving cell and the candidate cell is a non-terrestrial network (NTN) cell or a terrestrial network (TN) cell,
the TN cell comprises an evolved universal terrestrial radio access (E-UTRA) cell or a new radio (NR) and cell,
the handover command is a conditional handover command, and
the handover procedure is a conditional handover procedure.
